(19) United States
(12) Patent Application Publication
(10) Pub. No.: US 2012/0100912 A1
(43) Pub. Date: Apr. 26, 2012

(54) METHOD OF REUSING PHYSICS SIMULATION RESULTS AND GAME SERVICE APPARATUS USING THE SAME

(75) Inventors: Sung-Soo KIM, Daejeon (KR); Kyoung-Ill KIM, Seoul (KR); Choong-Gyoo LIM, Daejeon (KR); Jong-Ho WON, Daejeon (KR); Chang-Joon PARK, Daejeon (KR); Byoung-Tae CHOI, Daejeon (KR)

(73) Assignee: Electronics and Telecommunications Research Institute, Daejon (KR)

(21) Appl. No.: 13/280,463

(22) Filed: Oct. 25, 2011

(30) Foreign Application Priority Data
Oct. 25, 2010 (KR) 10-2010-0104169

(51) Int. Cl. A63F 13/00

(52) U.S. Cl. 463/31

(57) ABSTRACT

Disclosed herein are a method of reusing physics simulation results and a game service apparatus using the method. The game service apparatus includes a game service management server, a physics simulation index server, a physics computation cluster, and a rendering server. The game service management server manages physics simulation data corresponding to a game service. The physics simulation index server creates a spatial index structure corresponding to the physics simulation data, and performs spatial indexing for a user area using the spatial index structure. The physics computation cluster performs initial global simulation on the physics simulation data, manages initial global simulation results as reuse data, and performs local simulation on spatial indexing results for the user area. The rendering server merges the reuse data with local simulation results, renders merging results, and provides a game image to a user.

### CROSS REFERENCE TO RELATED APPLICATION

This application claims the benefit of Korean Patent Application No. 10-2010-0104169, filed on Oct. 25, 2010, which is hereby incorporated by reference in its entirety into this application.

### BACKGROUND OF THE INVENTION

1. Technical Field

The present invention relates generally to a method of reusing physics simulation results and a game service apparatus using the method and, more particularly, to a method of reusing physics simulation results using a central processing unit (hereinafter referred to as the “CPU”)-based cluster and a game service apparatus using the method.

2. Description of the Related Art

With the development of computer hardware, such as a CPU and a graphics processing unit (hereinafter referred to as the “GPU”), and Internet-based communication technology, various types of on-line game services are being developed.

In general, an on-line game includes a variety of components, including a background screen, background music, a user's character, and a variety of types of items and ornamentation. A service for such an on-line game is being provided to users via dedicated terminal programs for access to an on-line game server and playing of the game, which are distributed by an on-line game service provider.

However, the distribution of the dedicated terminal programs has the problem of being repeatedly developed and distributed for the same game for various operating systems (OSs) and types of hardware. Furthermore, a high-quality 3D game, including realistic fluid and rigid body simulation (hereinafter referred to as the “physics simulation”), requires a high-specification user terminal necessary to process a large amount of physics computation and high-quality rendering. Here, there arises a problem in that from the viewpoint of users, a game service can be provided only when the users purchase the corresponding hardware and therefore a financial burden attributable to the purchase of the hardware is imposed on the users.

### SUMMARY OF THE INVENTION

Accordingly, the present invention has been made keeping in mind the above problems occurring in the prior art, and an object of the present invention is to provide a method of reusing physics simulation results using a CPU-based cluster and a game service apparatus using the method.

In order to accomplish the above object, the present invention provides a game service apparatus, including a game service management server for managing physics simulation data corresponding to a game service; a physics simulation index server for creating a spatial index structure corresponding to the physics simulation data and performing spatial indexing for a user area using the spatial index structure; a physics computation cluster for performing initial global simulation on the physics simulation data, managing initial global simulation results as reuse data, and performing local simulation on spatial indexing results for the user area; and a rendering server for merging the reuse data with local simulation results, rendering merging results, and providing a game image to a user.

The spatial index structure may include a first space corresponding to an independent physics simulation space and a second space corresponding to a local physics simulation space.

The physics simulation index server may classify the physics simulation data as data corresponding to the first space or data corresponding to the second space, and stores it.

The game service apparatus may further include a simulation results storage server for storing the reuse data.

The physics simulation index server may include a spatial indexing management unit for creating the spatial index structure corresponding to the physics simulation data at a preprocessing step performed before the game service is provided to the user; and a user area indexing unit for performing spatial indexing of the user area using the spatial index structure at a step at which the game service is provided to the user.

The rendering server may provide the game image to the terminal of the user via Internet streaming.

In order to accomplish the above object, the present invention provides a method of reusing physics simulation results, including creating a spatial index structure corresponding to physics simulation data in a game using a game service apparatus; performing initial global simulation using the spatial index structure before execution of the game; when the game is executed, performing local simulation on spatial indexing results for a user area; merging initial global simulation results with local simulation results; and rendering merging results, and providing a game service to a user.

The performing initial global simulation may include loading physics simulation data corresponding to the game service; identifying initially loaded physics simulation data of the loaded physics simulation data using user-independent physics simulation data attributes; storing the identified physics simulation data in the spatial index structure; and performing initial global simulation using the spatial index structure.

The performing initial global simulation may further include storing the initial global simulation results in a simulation reuse cache.

The performing global simulation may include, when the game is executed, receiving information about the user area; extracting data, that is, a physics simulation target, by performing spatial indexing corresponding to the information about the user area; and performing user local simulation for each user area using the extracted data.

The method may further include merging the local simulation results with the initial global simulation results; and if merged results are different from the initial global simulation results, updating the simulation reuse cache with a different portion.

The providing a game service may include loading the initial global simulation results; and testing for a collision between data corresponding to the loaded results and corresponding character data of the user, performing rendering corresponding to collision test results, and then providing the game service.

The method may further include, if, as a result of the collision test, there is a collision, extracting physics simulation data by performing spatial indexing on data corresponding to the loaded results; performing local simulation using the extracted physics simulation data and the character data; merging the initial global simulation results with the local simulation results; and rendering a game scene corresponding to merged results, and providing the game service.

The method may further include, if, as a result of the collision test, there is no collision, rendering a game scene corresponding to the initial global simulation results and providing the game service.

The physics simulation data may be data corresponding to fluid and rigid body simulations included in the game.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an environment in which a game service is provided according to an embodiment of the present invention;

FIG. 2 is a diagram showing an example of a spatial index structure according to an embodiment of the present invention;

FIG. 3 is a diagram illustrating a method of reusing physics simulation results according to an embodiment of the present invention;

FIG. 4 is a diagram showing the configuration of a game service apparatus according to an embodiment of the present invention;

FIG. 5 is a drawing illustrating a method of performing physics simulation at a preprocessing step according to an embodiment of the present invention;

FIG. 6 is a diagram illustrating a method of performing local physics simulation for each user according to an embodiment of the present invention; and

FIG. 7 is a drawing illustrating a method of creating a game scene reusing physics simulation results according to an embodiment of the present invention.

### DESCRIPTION OF THE PREFERRED EMBODIMENTS

Reference now should be made to the drawings, in which the same reference numerals are used throughout the different drawings to designate the same or similar components.

The present invention will be described in detail below with reference to the accompanying drawings. Here, redundant descriptions and descriptions of well-known functions and elements that may unnecessarily make the gist of the present invention vague will be omitted. Embodiments of the present invention are provided to more fully describe the present invention to those having ordinary knowledge in the art to which the present invention pertains. Accordingly, the shapes and sizes of elements in the drawings may be exaggerated for the sake of clearer description.

A method of reusing physics simulation results and a game service apparatus using the same according to an embodiment of the present invention will be described in detail below with reference to the accompanying drawings.

First, a game provided by a game service device includes actual fluid and rigid body simulations (hereinafter referred to as “physics simulation”).

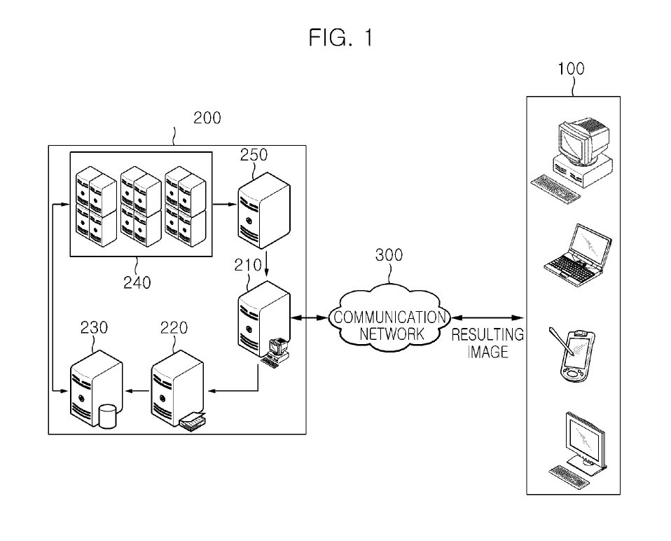

FIG. 1 is a diagram showing an environment in which a game service is provided according to an embodiment of the present invention.

Referring to FIG. 1, the environment in which the game service is provided includes the terminal 100 of a user who receives the game service and the game service apparatus 200 of a server which provides the game service.

The terminal 100 of the user may be connected to the game service apparatus 200 via one or more of various types of communication networks 300 such as a wired or wireless Internet network, and may receive the streaming-based game service from the game service apparatus 200.

The game service apparatus 200 does not perform the physics simulation and rendering of the game using the CPU and GPU of the terminal 100 and a program installed in a separate terminal, but executes the components of the game service using its own hardware resources, such as a CPU and a GPU. Here, the components of the game service include animation, a sound generation function, an artificial intelligence function, a physics simulation function, and a rendering function.

Thereafter, the game service apparatus 200 uses a streaming-based game service method of performing the components of the game service and providing corresponding game result images to the terminal 100 of the user as a stream.

The game service apparatus 200 according to the embodiment of the present invention provides a method of reusing the physics simulation results of the components of the game service and performing acceleration.

In detail, the game service apparatus 200 includes a game service management server 210, a physics simulation index server 220, a physics simulation results storage server 230, a CPU-based physics computation cluster 240, and a rendering server 250.

The game service management server 210 manages game service resources, geometrical information, and data corresponding to the game provided to the user via the terminal 100.

The physics simulation index server 220 creates a spatial index structure corresponding to physics simulation data at a preprocessing step before the provision of a game service to the user, and performs spatial indexing on a user area using the spatial index structure at the step at which the game service is provided to the user.

The physics simulation results storage server 230 stores physics simulation results that are obtained at the step at which the game is executed.

The CPU-based physics computation cluster 240 performs physics simulation using a spatial index structure at the preprocessing step and at the execution step.

The rendering server 250 merges initial global simulation results with local simulation results, renders a physics simulation game scene corresponding to the results of the merging, and provides game images to the user as an image stream.

Merging initial global simulation results with local simulation results and providing a game image according to an embodiment of the present invention corresponds to reusing physics simulation results and providing a game image, but the present invention is not limited thereto.

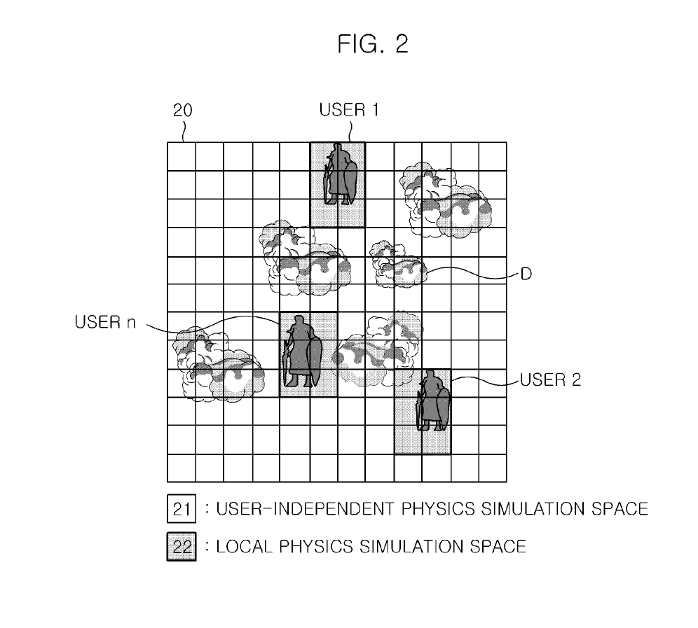

Next, a spatial index structure for physics simulation will be described in detail with reference to FIG. 2.

FIG. 2 is a diagram showing an example of a spatial index structure 20 according to an embodiment of the present invention.

First, the spatial index structure 20 corresponds to a 3D space acceleration structure, and functions to store and search physics simulation target data, that is, physics simulation data. The spatial index structure 20 may employ a data structure, such as Binary Space Partitioning (BSP), Bounding Volume Hierarchy (BVH), KD-tree, Grids, or Octree.

In FIG. 2, the spatial index structure 20 has been divided into 2D game spaces and represented in the form of a diagram. Here, the spatial index structure 20 includes a first space 21 corresponding to a user-independent physics simulation space and a second space 22 corresponding to a local physics simulation space.

The physics simulation index server 220 is configured to insert physics simulation data D into the spatial index structure 20, and to separately store data corresponding to the first space 21 which interacts with Non-Player Characters (NPCs) corresponding to characters who cannot play the game, and data corresponding to the second space 22 for each user. Here, the physics simulation data D corresponds to the entire game scene in the initial stage of the game, including a physics simulation scene.

For example, when the first space 21 is converted into the second space 22 so as to correspond to the corresponding character location of the user while the game is being played, the physics simulation index server 220 updates the attributes of the physics simulation data D, included in the corresponding area of the spatial index structure 20, to those of the second space 22, and separately manages them.

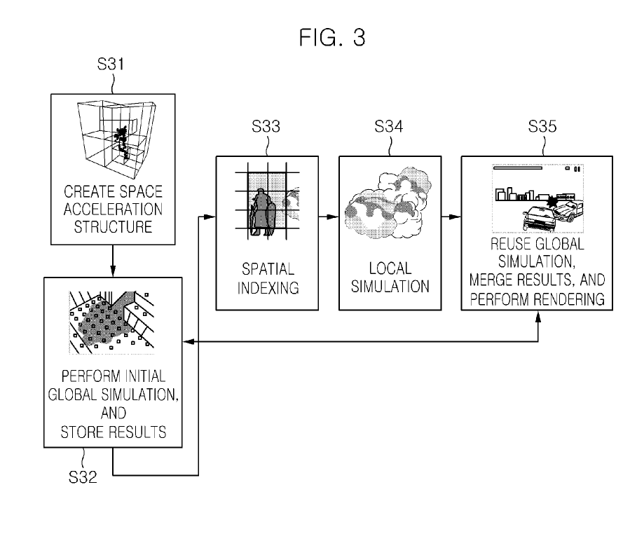

Next, a method in which the game service apparatus reuses physics simulation results will be described in detail with reference to FIG. 3.

FIG. 3 is a diagram illustrating a method of reusing physics simulation results according to an embodiment of the present invention.

Referring to FIG. 3, the game service apparatus 200 creates a spatial index structure 20 for physics simulation data D included in an initial scene that corresponds to an initial game service of a game service provided via the terminal 100 at step S31.

Before receiving an input signal corresponding to the performance of play, the game service apparatus 200 performs initial global simulation on a simulation scene included in a game service and stores performance results at step S32.

When a user area corresponding to the input signal is determined, the game service apparatus 200 performs spatial indexing for the user area using the spatial index structure 20 at step S33.

The game service apparatus 200 performs local simulation on spatial indexing results, that is, a local simulation target at step S34.

The game service apparatus 200 merges initial global simulation results with local simulation results, and renders the results of the merging, that is, a physics simulation game scene at step S35. Here, the rendering corresponds to the process of creating a game image including 3D physics simulation by imparting a sense of reality to the physics simulation game scene while taking into account external information such as a light source, a location, a color, etc.

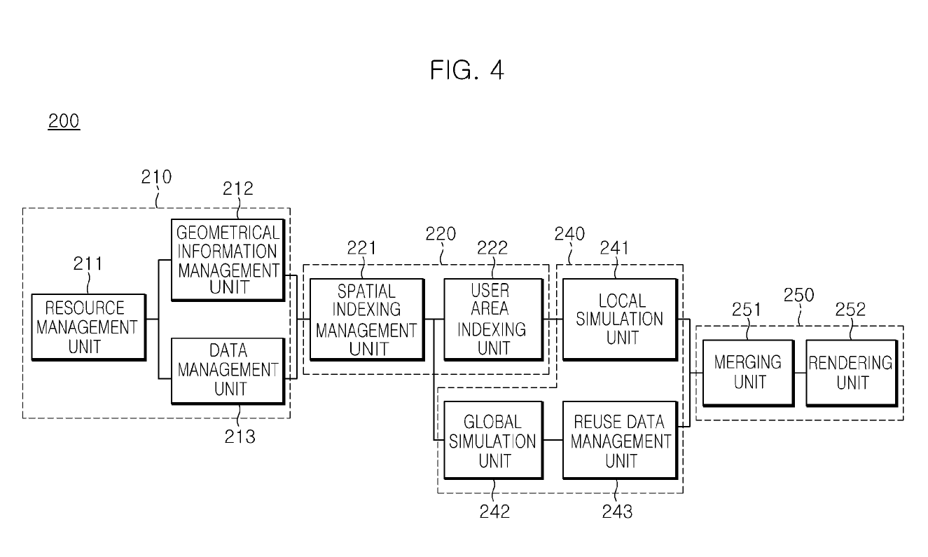

Next, the configuration of the game service apparatus 200 will be described in detail with reference to FIG. 4.

FIG. 4 is a diagram showing the configuration of a game service apparatus according to an embodiment of the present invention.

The game service apparatus 200 includes a game service management server 210, a physics simulation index server 220, a physics simulation results storage server 230, a CPU-based physics computation cluster 240, and a rendering server 250.

Referring to FIG. 4, the game service management server 210 includes a resource management unit 211, a geometrical information management unit 212, and a data management unit 213.

The resource management unit 211 manages game service resources, including a game user, game scenes, physics simulation data, etc.

The geometrical information management unit 212 manages the geometrical information of 3D objects that will be displayed in the game service. Here, the 3D objects include, for example, geographical features, buildings, characters, etc.

The data management unit 213 manages data about particles or rigid bodies for physics simulation.

The physics simulation index server 220 includes a spatial indexing management unit 221 and a user area indexing unit 222.

The spatial indexing management unit 221 creates the spatial index structure 20 by spatially dividing a 3D scene at the step performed immediately before the game service is provided to the terminal 100 of the user (hereinafter referred to as the “preprocessing step”), and manages it. Here, the spatial index structure 20 is created to determine visibility by efficiently rendering the geometrical information and the data or to detect a collision in physics-based simulation.

The user area indexing unit 222 performs spatial indexing on the user area using the spatial index structure 20 at the step of providing the game service.

The CPU-based physics computation cluster 240 includes a local simulation unit 241, a global simulation unit 242, and a reuse data management unit 243.

The local simulation unit 241 performs local simulation on spatial indexing results obtained by the user area indexing unit 222, that is, a local simulation target.

The global simulation unit 242 performs initial global simulation on a simulation scene, included in the game service, using the spatial index structure 20.

The reuse data management unit 243 manages initial global simulation results obtained by the global simulation unit 242, that is, reuse data.

The rendering server 250 includes a merging unit 251, and a rendering unit 252.

The merging unit 251 merges the local simulation results with the global simulation results.

The rendering unit 252 creates a resulting image by rendering a physics simulation game scene corresponding to the results of the merging obtained by the merging unit 251.

Finally, the rendering unit 252 sends the resulting image to the terminal 100 of the user via Internet streaming.

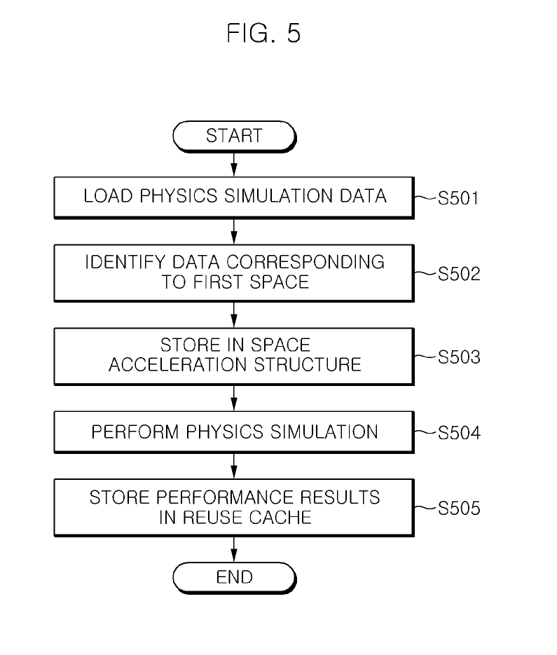

Next, a method of performing physics simulation at the preprocessing step will be described in detail with reference to FIG. 5.

FIG. 5 is a drawing illustrating the method of performing physics simulation at the preprocessing step according to an embodiment of the present invention.

The preprocessing step corresponds to the step performed immediately before the game service apparatus 200 provides the game service to the terminal 100 of the user.

Referring to FIG. 5, the game service apparatus 200 loads physics simulation data, including game scenes corresponding to the game service to be provided to the user, to memory at step S501.

The game service apparatus 200 identifies the initially loaded physics simulation data of the loaded physics simulation data using user-independent physics simulation data attributes at step S502. Here, the user-independent physics simulation data attributes corresponds to data attributes corresponding to the first space 21.

The game service apparatus 200 stores the indentified physics simulation data in the spatial index structure 20 at step S503.

The game service apparatus 200 performs physics-based simulation using the spatial index structure 20 at step S504.

The game service apparatus 200 stores simulation results in a simulation reuse cache (not shown) at step S505.

The simulation results created at the preprocessing step as described above will be used in subsequent game play as reuse data.

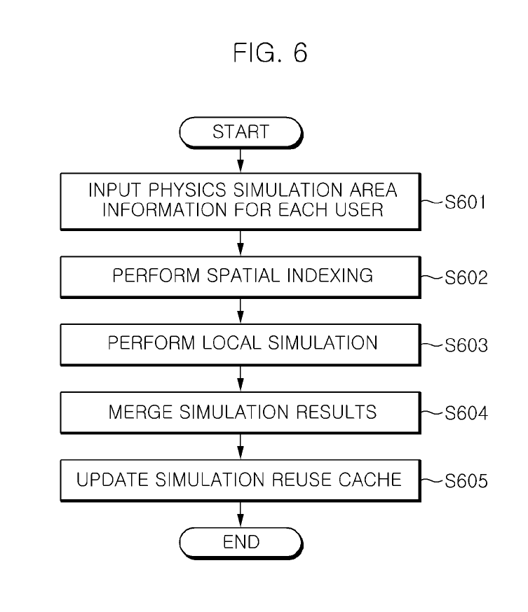

Next, a method of performing local physics simulation for each user will be described in detail with reference to FIG. 6.

FIG. 6 is a diagram illustrating the method of performing local physics simulation for each user according to an embodiment of the present invention.

The game service apparatus 200 includes the simulation results, created at the preprocessing step, in the simulation reuse cache.

Referring to FIG. 6, the game service apparatus 200 receives physics simulation area information for each user (or user area information) when the user plays the game at step S601.

The game service apparatus 200 performs spatial indexing corresponding to the received physics simulation area information for each user at step S602. Furthermore, the game service apparatus 200 extracts physics simulation target data by performing spatial indexing for physics simulation.

The game service apparatus 200 performs local simulation for each user using user input and data corresponding to spatial indexing results at step S603.

The game service apparatus 200 merges local simulation results with global simulation results created at the preprocessing step at step S604. Here, since generally a global simulation area corresponding to the global simulation results is considerably larger than a local simulation area corresponding to the local simulation results, the method of reusing the global simulation results obtained at the preprocessing step is advantageous in terms of computation cost.

When merging results are different from the global simulation results created at the preprocessing step, the game service apparatus 200 updates the simulation reuse cache with the changed portion at step S605.

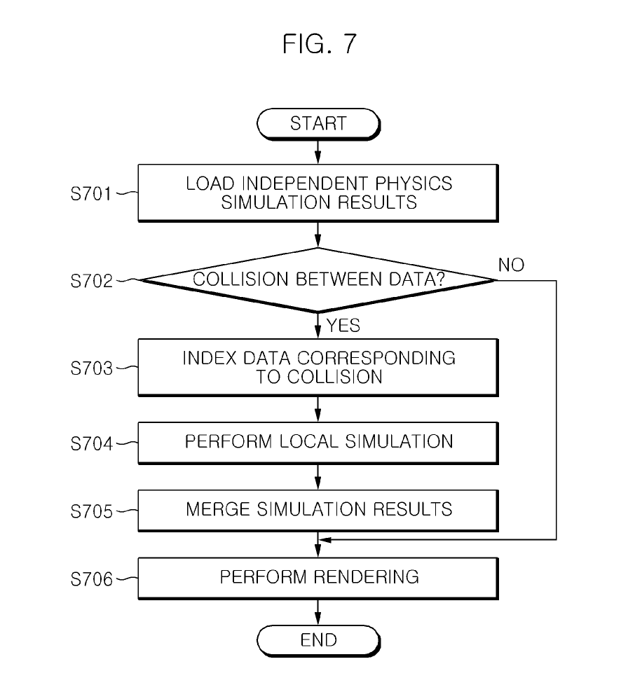

Next, a method of creating a game scene using the reuse physics simulation results stored in the simulation reuse cache will be described in detail with reference to FIG. 7.

FIG. 7 is a drawing illustrating the method of creating a game scene reusing physics simulation results according to an embodiment of the present invention.

The game service apparatus 200 loads user independent physics simulation results at step S701. Here, the user independent physics simulation results correspond to initial global simulation results obtained for a simulation scene included in an initial game service before the game is played, that is, physics simulation data.

The game service apparatus 200 determines whether to perform local simulation by testing for a collision between the corresponding character data of the user and physics simulation data at step S702.

If there is a collision, the game service apparatus 200 extracts physics simulation data by performing spatial indexing for the physics simulation data corresponding to a colliding portion at step S703.

The game service apparatus 200 performs local simulation using the extracted physics simulation data and the character data at step S704. Here, the local simulation method is configured to perform local simulation using a well-known method corresponding to rigid body simulation or fluid simulation.

The game service apparatus 200 merges the initial global simulation results, obtained at the preprocessing step, with local simulation results at step S705.

The game service apparatus 200 renders a game scene corresponding to the results of the merging of the initial global simulation results with the local simulation results at step S706.

If there is no collision, the game service apparatus 200 renders a game scene corresponding to the initial global simulation results at step S706.

According to the present invention, the game service apparatus performs physics simulation and rendering, which create bottlenecks in high-quality 3D on-line game services and therefore reduce speed, using game service provider-side hardware resources and a parallel computing environment, in particular, it divides a physics simulation operation into a user-independent portion and a dependent portion and executes them separately, thereby considerably reducing computation time.

According to the present invention, the game service apparatus, at the execution time, identifies a physics simulation area for each game user, performs local simulation, and then merges local simulation results with global simulation results computed for the preprocessing time, thereby being able to provide high-quality game images to game users and to also provide fast processing speed by reducing response time.

The game service apparatus can be extensively used not only for on-line game service but also for the design visualization field and the interactive ray tracing field, and can be flexibly used not only by on-line gainers but also by physics simulation professionals and high-quality 3D image content providers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A game service apparatus, comprising:
a game service management server for managing physics simulation data corresponding to a game service;
a physics simulation index server for creating a spatial index structure corresponding to the physics simulation data and performing spatial indexing for a user area using the spatial index structure;
a physics computation cluster for performing initial global simulation on the physics simulation data, managing initial global simulation results as reuse data, and performing local simulation on spatial indexing results for the user area; and
a rendering server for merging the reuse data with local simulation results, rendering merging results, and providing a game image to a user.

2. The game service apparatus as set forth in claim 1, wherein the spatial index structure comprises a first space corresponding to an independent physics simulation space and a second space corresponding to a local physics simulation space.

3. The game service apparatus as set forth in claim 2, wherein the physics simulation index server classifies the physics simulation data as data corresponding to the first space or data corresponding to the second space, and stores it.

4. The game service apparatus as set forth in claim 1, further comprising a simulation results storage server for storing the reuse data.

5. The game service apparatus as set forth in claim 1, wherein the physics simulation index server comprises:
a spatial indexing management unit for creating the spatial index structure corresponding to the physics simulation data at a preprocessing step performed before the game service is provided to the user; and
a user area indexing unit for performing spatial indexing of the user area using the spatial index structure at a step at which the game service is provided to the user.

6. The game service apparatus as set forth in claim 1, wherein the rendering server provides the game image to the terminal of the user via Internet streaming.

7. A method of reusing physics simulation results, comprising:
creating a spatial index structure corresponding to physics simulation data in a game using a game service apparatus;
performing initial global simulation using the spatial index structure before execution of the game;
when the game is executed, performing local simulation on spatial indexing results for a user area;
merging initial global simulation results with local simulation results; and
rendering merging results, and providing a game service to a user.

8. The method as set forth in claim 7, wherein the performing initial global simulation comprises:
loading physics simulation data corresponding to the game service;
identifying initially loaded physics simulation data of the loaded physics simulation data using user-independent physics simulation data attributes;
storing the identified physics simulation data in the spatial index structure; and
performing initial global simulation using the spatial index structure.

9. The method as set forth in claim 8, wherein the performing initial global simulation further comprises storing the initial global simulation results in a simulation reuse cache.

10. The method as set forth in claim 7, wherein the performing global simulation comprises:
when the game is executed, receiving information about the user area;
extracting data, that is, a physics simulation target, by performing spatial indexing corresponding to the information about the user area; and
performing user local simulation for each user area using the extracted data.

11. The method as set forth in claim 10, further comprising:
merging the local simulation results with the initial global simulation results; and
if merged results are different from the initial global simulation results, updating the simulation reuse cache with a different portion.

12. The method as set forth in claim 7, wherein the providing a game service comprises:
loading the initial global simulation results; and
testing for a collision between data corresponding to the loaded results and corresponding character data of the user, performing rendering corresponding to collision test results, and then providing the game service.

13. The method as set forth in claim 12, further comprising:
if, as a result of the collision test, there is a collision, extracting physics simulation data by performing spatial indexing on data corresponding to the loaded results;
performing local simulation using the extracted physics simulation data and the character data;
merging the initial global simulation results with the local simulation results; and
rendering a game scene corresponding to merged results, and providing the game service.

14. The method as set forth in claim 12, further comprising, if, as a result of the collision test, there is no collision, rendering a game scene corresponding to the initial global simulation results and providing the game service.

15. The method as set forth in claim 7, wherein the physics simulation data is data corresponding to fluid and rigid body simulations included in the game.
